(19) United States
(12) Patent Application Publication
(10) Pub. No.: US 2025/0391109 A1
(43) Pub. Date: Dec. 25, 2025

(54) HIERARCHICAL PARALLEL LOCALLY ORDERED CLUSTERING

(71) Applicant: Advanced Micro Devices, Inc., Santa Clara, CA (US)

(72) Inventor: Carsten Benthin, Munich (DE)

(73) Assignee: Advanced Micro Devices, Inc., Santa Clara, CA (US)

(21) Appl. No.: 18/750,148

(22) Filed: Jun. 21, 2024

(51) Int. Cl. G06T 17/00

(52) U.S. Cl. CPC G06T 17/005

(57) ABSTRACT

Techniques herein involve generating a bounding volume hierarchy in a fast and accurate manner. The techniques begin with a quickly built initial BVH and traverse that initial BVH in a bottom-up manner to generate a new BVH. The algorithm begins at the bottom level, setting the bottom-most primitive nodes as nodes in the new BVH and follows the initial BVH up, collecting uncombined nodes from lower levels to higher nodes. When the algorithm has collected a threshold number of such nodes at a node of the initial BVH, the algorithm builds a new subtree for that node by combining the threshold number of such nodes, and adds that new subtree to the new BVH. This algorithm is efficiently parallelizable by immediately switching from the traversal phase to the combining phase and using all work-items of a wavefront for such combining.

### BACKGROUND

In image synthesis, ray tracing is utilized to find a nearest intersection of a given ray with a scene where light propagation is simulated.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates operations for building a bounding volume hierarchy, according to an example;

FIG. 6 illustrates a BVH generated using a linear BVH technique;

FIGS. 7A-7D illustrate an example set of operations for creating a new BVH from an initial BVH, according to an example;

FIGS. 8 and 9 illustrate parallelized generation of the BVH; and

FIG. 10 illustrates a method for generating a BVH.

### DETAILED DESCRIPTION

Ray tracing is a rendering technique whereby rays are cast into a scene and pixels of a render target are colored based on which objects the rays intersect. To speed such operations up, a ray tracing system typically builds an acceleration structure such as a bounding volume hierarchy. Such a structure has a hierarchy of levels, where each level can include bounding volumes that bound the geometry of lower levels.

Techniques herein involve generating a bounding volume hierarchy in a fast and accurate manner. The techniques begin with a quickly built initial BVH and traverse that initial BVH in a bottom-up manner to generate a new BVH. The algorithm begins at the bottom level, setting the bottom-most primitive nodes as nodes in the new BVH and follows the initial BVH up, collecting uncombined nodes from lower levels to higher nodes. When the algorithm has collected a threshold number of such nodes at a node of the initial BVH, the algorithm builds a new subtree for that node by combining the threshold number of such nodes, and adds that new subtree to the new BVH. This algorithm is efficiently parallelizable by immediately switching from the traversal phase to the combining phase and using all work-items of a wavefront for such combining.

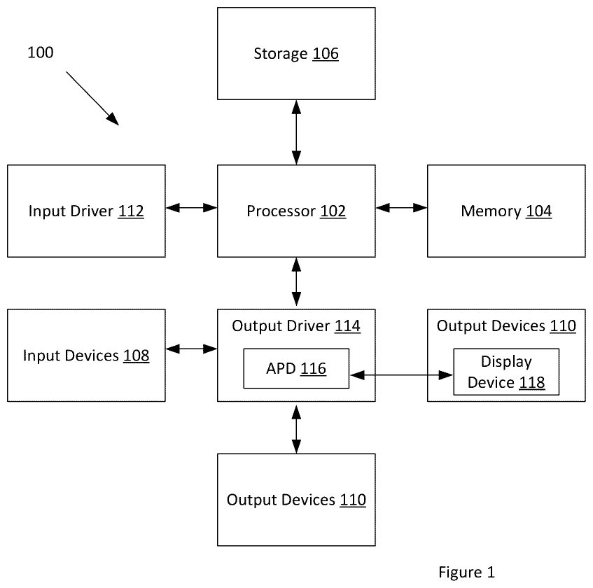

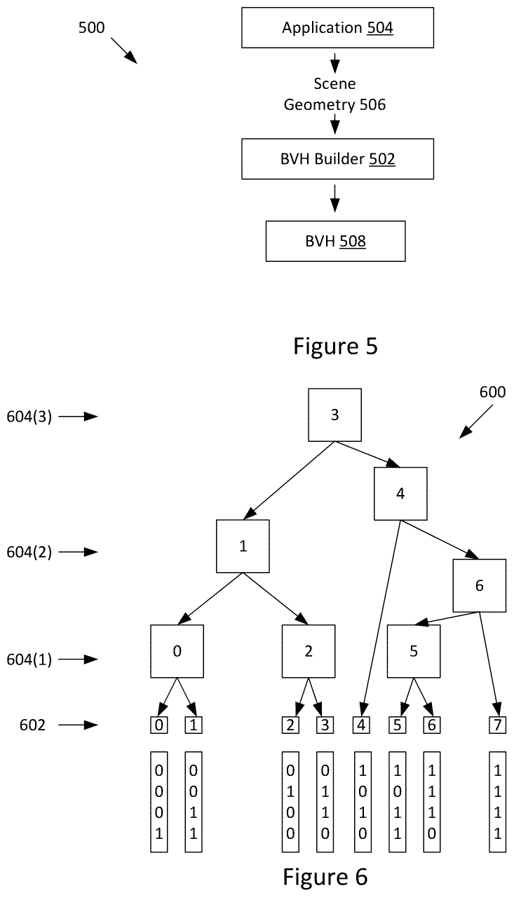

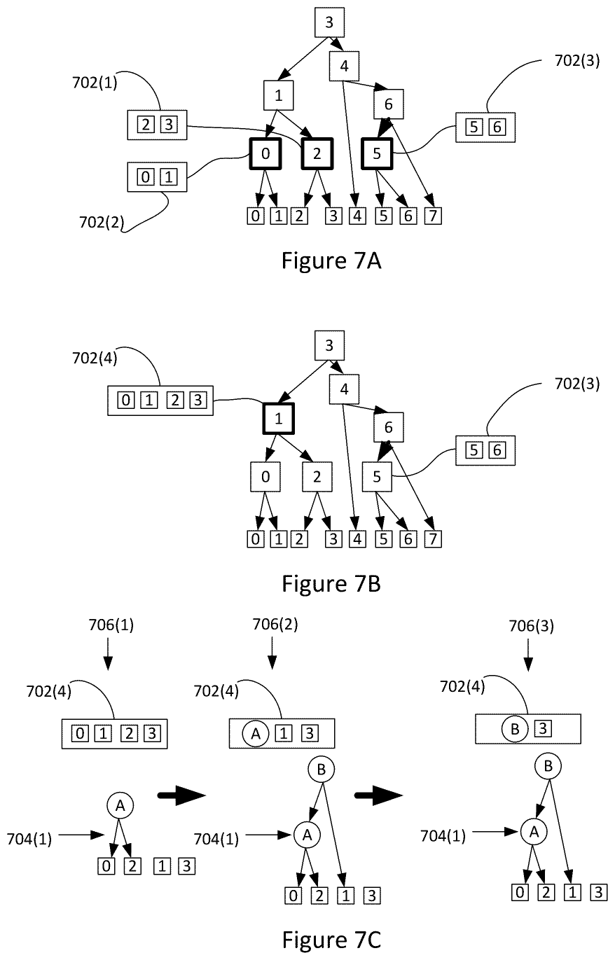

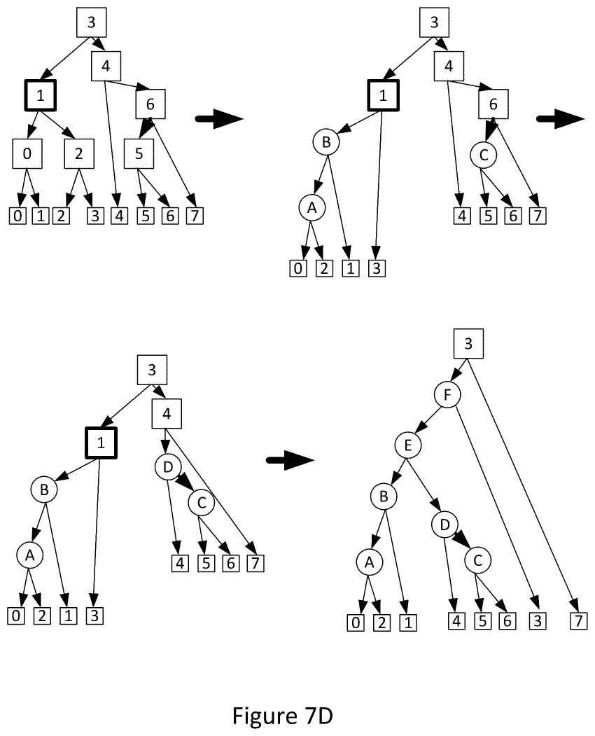

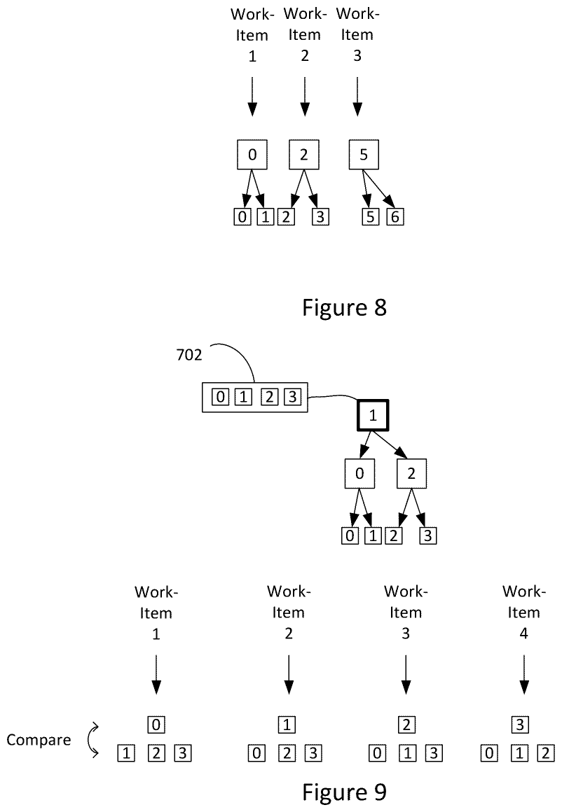

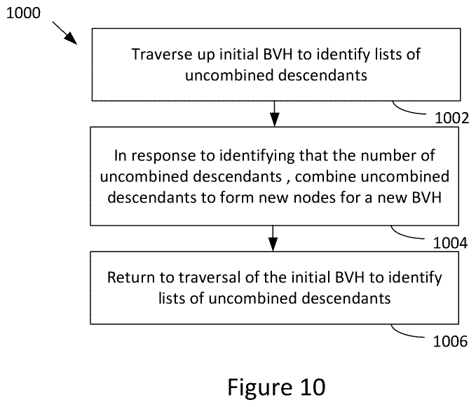

In the present disclosure, FIGS. 1-4 provide background for ray tracing. FIG. 5 illustrates operations of a BVH builder. FIG. 6 illustrates an initial BVH. FIGS. 7A-7D illustrate generating a new BVH from the initial BVH. FIGS. 8 and 9 illustrate parallelization. FIG. 10 describes a method for performing BVH building.

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

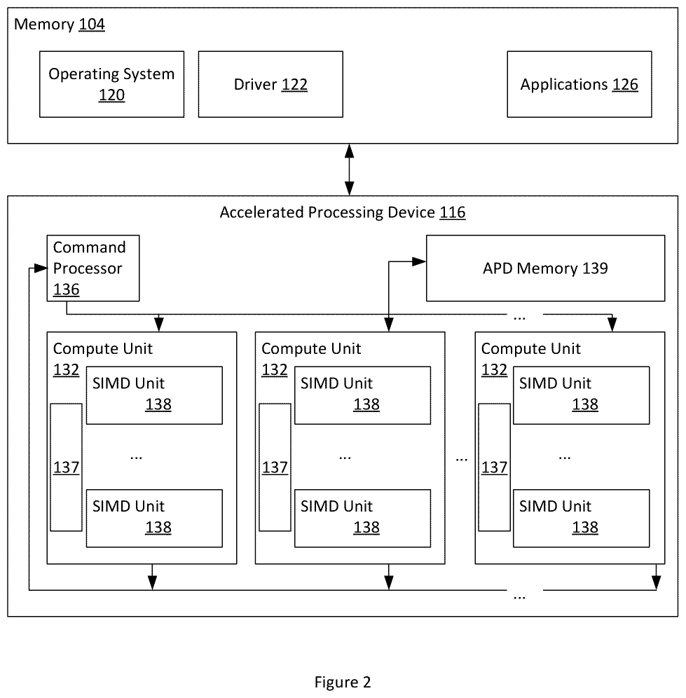

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. The driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The compute units 132 are sometimes referred to as “parallel processing units 202” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

The APD 116 is configured to implement features of the present disclosure by executing a plurality of functions as described in more detail below. For example, the APD 116 is configured to receive images comprising one or more three dimensional (3D) objects, divide images into a plurality of tiles, execute a visibility pass for primitives of an image, divide the image into tiles, execute coarse level tiling for the tiles of the image, divide the tiles into fine tiles and execute fine level tiling of the image. Optionally, the front end geometry processing of a primitive determined to be in a first one of the tiles can be executed concurrently with the visibility pass.

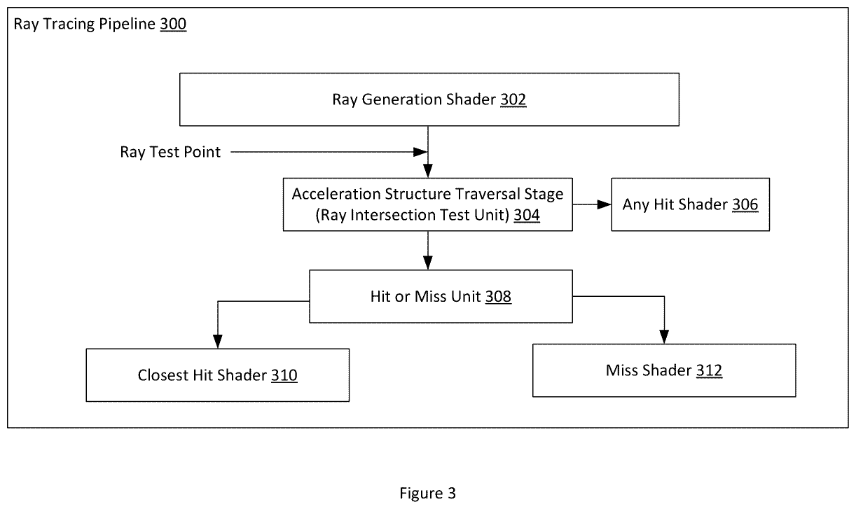

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

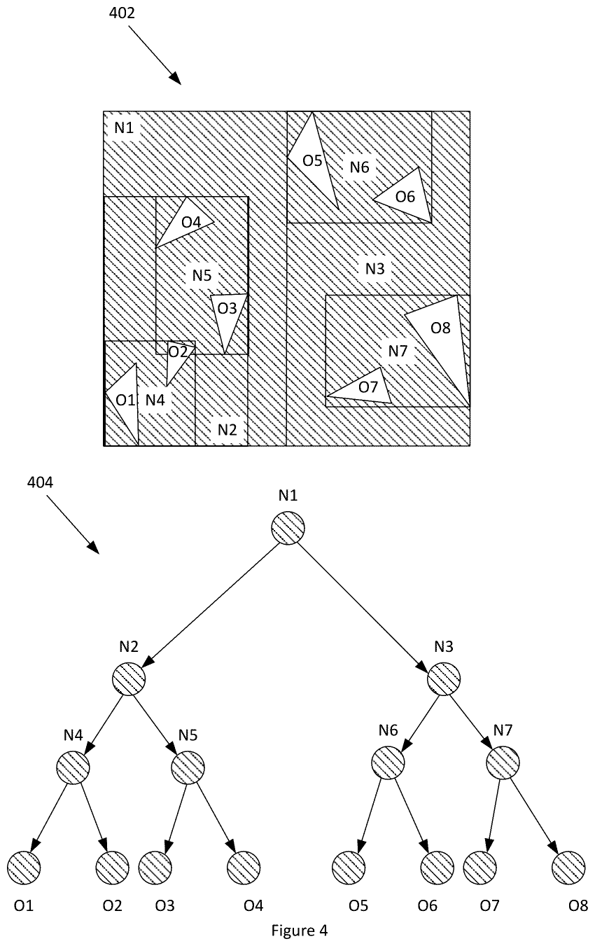

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that No succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

FIG. 5 illustrates operations for building a bounding volume hierarchy, according to an example. Operation 500 involves a BVH builder 502 accepting scene geometry 506 from an entity (such as an application 504). The BVH builder 502 generates a BVH 508 for the scene geometry 506. The BVH builder 502 is implemented in technically feasible manner. In some examples, the BVH builder 502 is software executed on one or more processors, hardware, such as fixed-function or programmable processors, or is embodied in any other technically feasible manner. In some examples, the BVH builder 502 includes a portion of the driver 122 and one or more shader programs that the driver 122 causes to execute on the compute units 132. In some examples, a combination of the driver 122 and shader programs perform the functionality of the BVH builder 502. In some such examples, the driver 122 accepts the scene geometry 506 and spawns shader programs to generate the BVH 508 based on the geometry. In some examples, the shader programs use hardware acceleration for one or more aspects of building the BVH 508.

The present disclosure includes techniques by which the BVH builder 502 generates a BVH. These techniques include generation of a BVH based on an implicit “initial” BVH.

Any technique could be used to generate the initial BVH, but one simple, efficient technique is a linear BVH (“LBVH”). According to this technique, Morton codes are first calculated for primitives (e.g., triangles) and then primitives are sorted by the Morton codes. A Morton code is an integer value that encodes three-dimensional positional information in the bits of the integer. In some examples, a Morton code includes alternating or interlaced bits from each dimension, in order of most significant to least significant. In some examples, the order of the bits thus can be represented as X5Y5Z5X4Y4Z4 . . . , where “X,” “Y,” or “Z” represents the axis, and the following number represents the bit order, with higher number representing more significant bits than lower number. It should be understood that this is just an example and that there are many techniques for generating Morton codes that do not require strictly interleaving one bit from each dimension in an alternating manner. For instance, it is possible to use multiple bits consecutively from any one or more axes, and to include more bits from one axis over another. Morton codes are an integer representation of a spatial position, so sorting primitives by Morton codes represents sorting primitives spatially. In some examples, the Morton codes are generated from the centroid of the primitive (e.g., triangle), or represent another point representative of the primitive.

Sorting primitives by Morton codes as described above directly creates an implicit tree structure. Any node is defined by a consecutive range of Morton codes in the sorted set. Each node in this implicit tree structure can have one or more children. The union of Morton codes represented by all children of a node is identical to the set of Morton codes that defines the node. Delineation between children of a node is defined using one or more split points that define one or more splits between the Morton codes. The one or more split points can be determined in any technically feasible manner.

FIG. 6 illustrates a BVH 600 generated using the LBVH technique as described above. As can be seen, there is a primitive level 602 including the primitives sorted by Morton codes. The primitives are represented with smaller boxes whose number represents the order of the primitive in the Morton code order. The vertical box with binary encoding represents the Morton code corresponding to the primitive immediately above that vertical box. The BVH 600 also includes hierarchy levels 604, each of which includes one or more non-leaf nodes. As stated above, each non-leaf node is associated with the union of primitives of the child nodes of that non-leaf node. The child nodes are either the primitives of the primitive level 602 or another non-leaf node of a hierarchy level 604.

As stated above, the present disclosure generates a new BVH based on the initial BVH such as the implicit BVH 600 generated using the LBVH technique. The BVH builder generates the new BVH by traversing the initial BVH in a bottom-up manner and generating new nodes for the new BVH by analyzing the content of the initial BVH. More specifically, to generate the new BVH, the BVH builder 502 begins with the “leaves” (primitives or leaf nodes) of the initial BVH 600 and traverses up that BVH until the BVH builder 502 arrives at a node having at least a threshold number of uncombined descendants. Then, the BVH builder 502 combines those uncombined descendants until the remaining number of uncombined descendants is below the threshold. In some examples, the BVH builder 502 repeats these operations until a root node has been generated. An “uncombined descendant” is either a primitive from the primitive level 602 or a node for which no node of the new BVH is a parent. In other words, except for the leaves/primitives, an uncombined descendant is a node that has a child in the new BVH but has no parent.

When the BVH builder 502 combines nodes for a particular node of the initial BVH, the BVH builder 502 generates a new set of nodes that includes the newly combined node as well as the remainder of the uncombined descendants. This new set of nodes becomes the new list of “uncombined descendants” for the node. In an example (not referring to any figure in particular), where a node has uncombined descendants 1, 2, 3, and 4, if the BVH builder 502 combines nodes 1 and 2 to form node A, then the new list of uncombined descendants is A, 3, and 4 (and does not include nodes 1 and 2 because those nodes are no longer “uncombined”). When the BVH builder 502 combines nodes, the BVH builder 502 generates a new node for the new BVH and makes the combined nodes children of that new node.

The BVH builder 502 combines descendants of a node in this manner until there are fewer uncombined descendants than the threshold, as described above. At this point, the node has a smaller list of uncombined descendants. This list is propagated up to the next higher level when the BVH builder 502 moves up to the next level. At any given node at the next level, that node is given the combination of the list of uncombined descendants from each child of that node. In other words, because each node propagates this list up to its parent, the parent has a list that encompasses the union of all uncombined descendants of all child nodes of that parent node. The BVH builder 502 repeats this process, moving up the initial BVH and creating the new BVH until a root node has been generated for the new BVH.

Above, it is stated that the BVH builder 502 processes a node of the initial BVH to generate a new BVH by combining uncombined descendants corresponding to the node of the initial BVH. This combining is now described. Beginning with a node of the initial BVH that corresponds to uncombined descendants, the BVH builder 502 combines such uncombined descendants in the following manner. The BVH builder 502 selects a subset of the uncombined descendants based on a selection criterion. Then the BVH builder 502 generates a new node for the new BVH, where that new node is a parent of each of the nodes corresponding to the uncombined descendants. Thus, it is possible that a given set of uncombined descendants results in the creation of multiple nodes at multiple different levels. For example, if a node has four uncombined descendants numbered 1, 2, 3, and 4, and the BVH builder 502 combines them as first a first node with children 1 and 2, then a second node with children first node and 3, and then a third node with children second node and 4, then there are three levels in this hierarchy.

FIGS. 7A-7D illustrate an example set of operations for creating a new BVH from an initial BVH, according to an example. In these operations, the threshold number of uncombined descendants to trigger combination is 3, meaning that if a node of the initial BVH has at least 3 uncombined descendants, then the BVH builder 502 will perform combination for that node and if there are fewer than 3, then the BVH builder 502 will not perform such combination. In FIG. 7A, the BVH builder 502 analyzes node 0 to determine whether combination should occur for the uncombined descendants of that node. This node has two uncombined descendants-primitive nodes 0 and 1. Since this is less than the threshold, the BVH builder 502 does not perform a combination for node 0. A similar result occurs for nodes 2 and 5. As a result of these operations, node 0 passes up, as uncombined descendants, leaf nodes 0 and 1 to node 1 and node 2 passes up leaf nodes 2 and 3 to node 1, so that node 1 has, as uncombined descendants, leaf nodes 0-4. Similarly, node 5 passes up leaf nodes 5 and 6. The list of uncombined descendants for each of nodes 0, 2, and 5 are shown as 702(1), 702(2), and 702(3).

At operation 7B, the BVH builder 502 traverses up to node 1, propagating the uncombined descendants from the children of node 1 to node 1 itself. Thus in the operation at 7B, node 1 has uncombined descendants 0, 1, 2, and 3. Note that the nodes of the initial BVH, themselves, are not propagated up in this case—it is the list of their uncombined descendants that are propagated up. At this point, the list 702(4) has at least the threshold number of uncombined descendants, and so the BVH builder 502 combines the nodes into new nodes for the new BVH. Combination includes combining the uncombined descendants of the node to form new nodes for the new BVH (a “subtree”).

FIG. 7C illustrates forming the subtree 704(1). In this operation, the BVH builder 502 determines which nodes to combine based on a combination criterion and combines those nodes, then repeats until the number of uncombined descendants is less than the threshold. At sub-step 706(1), the BVH builder 502 determines that uncombined descendants 0 and 2 are to be combined based on the selection criterion and thus generates a new node for the new BVH-node “A.” At sub-step 706(2), the BVH builder 502 determines that uncombined descendants A and 1 are to be combined and thus generates a new node—B—as parent to A and 1. Thus the BVH builder 502 generates node B, having children A and 1 as shown in operation 706(2). Operation 706(3) illustrates the final state of this operation, with nodes B and 3 as uncombined descendants that are passed up to the parent of initial BVH node 1, which is node 3, for the purpose of combination for that node.

FIG. 7D illustrates subsequent operations for processing the remaining nodes of the BVH. Specifically, the BVH builder 502 would perform combination for node 6, which has uncombined descendants 5, 6, and 7. In an example, the combination for node 6 generates node C, which parents nodes 5 and 6, and passes the list of uncombined descendants of C and 7 to node 4, which has list 4, C, and 7. Node 4 combines nodes 4 and C into node D and passes nodes D and 7 as the list of uncombined descendants of node 4 to node 3. Node 3 now has, as its list of uncombined descendants, nodes B, 3, D, and 7, and combines those nodes as well to form node E from nodes B and D, and node F from E and 3. At this point, the list only has nodes E and F, and no more combination occurs. As this is the root node, the final set of nodes are set as children of the new root node.

Above, it is stated that a selection criterion is used to select nodes from a list of uncombined descendants. Any selection criterion can be used, but one example is a surface area heuristic. In the surface area heuristic, the combination that produces the lowest total box surface area is selected for combination. More specifically, out of a set of uncombined descendants, the BVH builder 502 determines which combination (e.g., which two) would have a tightly fitting bounding box whose total surface area—the sum of the areas of the faces of that box—is the smallest, and selects that combination as the selected descendants.

In summary, the BVH builder 502 sorts Morton codes of primitives, resulting in an implicit initial BVH (e.g., LBVH). Then, the BVH builder 502 generates nodes of the new BVH in a bottom-up manner, based on the nodes of the initial BVH. The BVH builder 502 iteratively traverses up, where in each iteration, the BVH builder 502 begins with a set of one or more nodes of the new BVH. The BVH builder 502 identifies the primitive of the initial BVH that is considered the most immediate ancestor to the set of one or more nodes of the BVH. Additionally, the BVH builder 502 propagates the “uncombined descendants” for the set of one or more nodes of the new BVH to that most immediate ancestor. The BVH builder 502 combines this for all children of this most immediate ancestor, so that the most immediate ancestor has a list of uncombined descendants that encompasses all Morton codes of the range corresponding to the most immediate ancestor. The BVH builder 502 determines whether to combine such uncombined descendants based on the number corresponding to the most immediate ancestor. Specifically, if the number is greater than a threshold, then combining occurs and if the number is not greater than the threshold, then combining does not occur.

If combining does not occur for a node of the initial BVH (e.g., because the number of nodes in the list is below the threshold), then the BVH builder 502 propagates the list of uncombined descendants to the next most immediate ancestor, and another iteration is performed for that ancestor. In the example of FIG. 7A, non-leaf nodes 0 and 2 do not have sufficient children for combination, so their children are propagated up to non-leaf node 1.

If combining does occur, then the BVH builder 502 performs such combination. This combination involves removing, from the list of uncombined descendants, nodes, based on a selection criteria, generating a new node that parents the removed nodes, and placing the new node into the list of uncombined descendants. This combining repeats for the list until the list has fewer than the threshold number, at which point the BVH builder 502 returns to traversing up the BVH.

It is possible to parallelize the above operations for performance, and FIGS. 8 and 9 illustrate such parallelization. In an example shown in FIG. 8, one or more kernels (e.g., general purpose shader programs) operate to generate the new BVH from the implicit initial BVH as described. In such an example, to build a BVH, kernels perform the following operations: select a node of the initial BVH to analyze. This analysis involves determining whether to perform combination for the list of uncombined descendants of that node of the initial BVH. Each such analysis can be performed by a different work-item in a kernel dispatch, and thus it is possible that a single wavefront includes multiple work-items that are performing such analysis in parallel. In an example, to analyze the initial BVH depicted in FIG. 7A in this manner, each work-item of a wavefront analyzes in parallel a different one of non-leaf node 0, non-leaf node 2, and non-leaf 5. Specifically, each work-item determines whether the non-leaf node has a list of uncombined descendants that includes at least the threshold number of elements.

In the event that at least one work-item determines that its non-leaf node has a list that includes at least the threshold number of elements, the wavefront including that work-item switches into combination mode in which the uncombined descendants are combined to form new nodes for the new BVH. In some examples, the wavefront immediately switches into the combination mode in response to such a determination, with each work-item in the wavefront participating in the combining operation. Because each such work-item is participating, if the work-items find multiple nodes of the initial BVH that have at least the threshold number of elements, then the wavefront serializes the combination modes. In other words, the wavefront performs such combination mode for one of the initial BVH nodes, and when that is done, performs such combination for another, etc., until there are no more such nodes left. At that point, the wavefront returns to evaluating the nodes of the initial BVH to determine whether combination should occur (e.g., based on the threshold) in parallel.

FIG. 9 illustrates parallel analysis for combining uncombined descendants, according to an example. In this example, each work-item of a wavefront analyzes a particular uncombined descendant of the list of uncombined descendants, in order to identify the set of uncombined descendants to combine into a new node of the new BVH. In some examples, it is each active work-item of a wavefront that performs this analysis, since the wavefront may be wider than the number of uncombined descendants (since it is, in some examples, the maximum number that is equal to the wavefront width). In some examples, a non-active work-item is switched off through predication. In an example, each work-item calculates a metric or score for multiple combinations including the uncombined descendant assigned to the work-item and each other uncombined descendant. After this is complete for each work-item, the work-items select a set of uncombined descendants to combine based on the metrics or scores. In an example, each work-item determines the tightly fitting bounding volumes for each combination of the descendant assigned to that work-item and each other descendant being considered by the wavefront. Then, the work-item calculates a heuristic such as the total surface area of each face of each such tightly fitting bounding volume. The work-item selects one such heuristic, such as the lowest such heuristic and notes the uncombined descendant combination this is associated with. After this, if any two work-items identify the same combination of uncombined descendants (e.g., 1 and 2), then the wavefront determines that this combination is the combination that is selected. At the end of this set of operations, the wavefront has identified a combination of uncombined descendants to combine. The wavefront repeats this with the remaining uncombined descendants (e.g., with the descendants that were combined replaced with the newly generated node, and the other descendants that had not yet been combined) until the remaining number of uncombined descendants is below the threshold. Then, the wavefront either moves to combining for a different initial BVH or if none are left, returns to traversing up the BVH (e.g., FIG. 8). In some examples, the threshold is equal to half of the wavefront width, where the wavefront width is the number of work-items in the wavefront. In addition, in some examples, the maximum number of uncombined descendants that are compared in this manner for combination is equal to the wavefront width (where 4 is used only as an example, but wavefronts can be much larger).

FIG. 10 is a flow diagram of a method 1000 for generating a new BVH from an initial BVH (e.g., a BVH generated via the linear BVH algorithm), according to an example. Although described with respect to the system of FIGS. 1-9, those of skill in the art will understand that any system configured to perform the steps of the method 1000 in any technically feasible order falls within the scope of the present disclosure.

Prior to the method 1000, a BVH builder 502 obtains an initial BVH (such as one generated using LBVH), either by generating the initial BVH or by obtaining it in some other manner. This operation can involve simply sorting Morton codes for the primitives of the BVH, which results in an implicitly generated initial BVH. At step 1002, the BVH builder 502 traverses up the initial BVH to identify lists of uncombined descendants. As described elsewhere herein, the BVH builder 502 begins with the primitive level, converting those primitives to primitives of the new BVH. These primitives are also “uncombined descendants” for the purposes of analysis concerning such items. Then, the BVH builder 502 follows the nodes of those primitives up to a node of the initial BVH, propagating the uncombined descendants to that node. After traversing up, the BVH builder 502 determines whether the node traversed to has a list of uncombined descendants with a number of such descendants at least equal to a threshold, and moves to step 1004 in that event. If not, then the BVH builder 502 traverses up to the following parent, propagating the uncombined descendants up to that parent. It should be understood that the list of uncombined descendants for a node to which the BVH builder 502 has propagated up includes the uncombined descendants for all children of that node.

At step 1004, in response to identifying that the number of uncombined descendants of a node of the initial BVH is greater than or equal to the threshold, the BVH builder 502 combines the uncombined descendants to form new nodes for the new BVH. This operation includes iteratively combining uncombined descendants into newly generated nodes until the remaining number of uncombined nodes is below the threshold. Each combination generates a new node that parents the nodes that are combined. The resulting set of nodes form a part of the new BVH. After this combination is performed for all initial BVH nodes having at least the threshold number of uncombined nodes, the BVH builder 502 moves to step 1006. At step 1006, the BVH builder 502 returns to traversal of the initial BVH to identify lists of uncombined descendants, as in step 1002. The BVH builder 502 repeats this step and step 1004 until a termination criterion is met, such as that a root node has been generated for the new BVH. As described with respect to FIGS. 8 and 9, step 1002 and 1004 may be performed in parallel. Further, step 1002 may be repeated until at least one list having at least a threshold number of uncombined descendants is identified, at which time the wavefront switches to step 1004 to combine the nodes, until no such nodes (having a number of uncombined descendants at least equal to the threshold number) exist.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the SIMD units 138, the ray tracing pipeline 300, including the ray generation shader 302, acceleration structure traversal stage 304, any hit shader 306, hit or miss unit 308, closest hit shader 310, miss shader 312, or BVH builder 502 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for generating a bounding volume hierarchy (“BVH”), the method comprising:
identifying that a number of uncombined descendants for a node of an initial BVH, is greater than or equal to a threshold; and
in response to the identifying, combining the uncombined descendants to form a subtree to add to a new BVH.

2. The method of claim 1, wherein each uncombined descendant is a node of the new BVH for which no node of the new BVH is a parent.

3. The method of claim 1, wherein combining the uncombined descendants includes selecting uncombined descendants from the uncombined descendants for the node based on a selection criterion, forming a new node for the BVH, and setting, as parent for the selected uncombined descendants, the new node.

4. The method of claim 3, further comprising repeating the combining until the number of uncombined descendants for the node is less than the threshold.

5. The method of claim 1, wherein the identifying is part of a parallel analysis operation performed in parallel by multiple work-items of a wavefront.

6. The method of claim 5, wherein the combining is also performed by the wavefront.

7. The method of claim 6, wherein the wavefront performs the combining upon detecting that at least one node of the initial BVH has a number of uncombined descendants below the threshold.

8. The method of claim 6, wherein the combining comprises each active work-item of the wavefront being assigned an uncombined descendant for analysis.

9. The method of claim 8, wherein the analysis comprises selecting a set of uncombined descendants to combine.

10. A system for generating a bounding volume hierarchy (“BVH”), the system comprising:
a memory configured to store information for a new BVH; and
a processor configured to perform operations comprising:
identifying that a number of uncombined descendants for a node of an initial BVH, is greater than or equal to a threshold; and
in response to the identifying, combining the uncombined descendants to form a subtree to add to the new BVH.

11. The system of claim 10, wherein each uncombined descendant is a node of the new BVH for which no node of the new BVH is a parent.

12. The system of claim 10, wherein combining the uncombined descendants includes selecting uncombined descendants from the uncombined descendants for the node based on a selection criterion, forming a new node for the BVH, and setting, as parent for the selected uncombined descendants, the new node.

13. The system of claim 12, further comprising repeating the combining until the number of uncombined descendants for the node is less than the threshold.

14. The system of claim 10, wherein the identifying is part of a parallel analysis operation performed in parallel by multiple work-items of a wavefront.

15. The system of claim 14, wherein the combining is also performed by the wavefront.

16. The system of claim 15, wherein the wavefront performs the combining upon detecting that at least one node of the initial BVH has a number of uncombined descendants below the threshold.

17. The system of claim 15, wherein the combining comprises each active work-item of the wavefront being assigned an uncombined descendant for analysis.

18. The system of claim 17, wherein the analysis comprises selecting a set of uncombined descendants to combine.

19. A non-transitory computer-readable medium storing instructions that, when executed by a processor, cause the processor to perform operations comprising:
identifying that a number of uncombined descendants for a node of an initial BVH, is greater than or equal to a threshold; and
in response to the identifying, combining the uncombined descendants to form a subtree to add to a new BVH.

20. The non-transitory computer-readable medium of claim 19, wherein each uncombined descendant is a node of the new BVH for which no node of the new BVH is a parent.
